(19) United States
(12) Patent Application Publication
(10) Pub. No.: US 2026/0001663 A1
(43) Pub. Date: Jan. 1, 2026

(54) Systems and Methods for Controlled Deployment of Elastically Foldable Arrays

(71) Applicant: California Institute of Technology, Pasadena, CA (US)

(72) Inventors: Sergio Pellegrino, Pasadena, CA (US); Maria Kechri, Pasadena, CA (US); Chinthaka Mallikarachchi, Pasadena, CA (US); Alan Truong, Rosemead, CA (US); Jonathan Sauder, La Crescenta, CA (US)

(73) Assignee: California Institute of Technology, Pasadena, CA (US)

(21) Appl. No.: 19/252,819

(22) Filed: Jun. 27, 2025

Related U.S. Application Data
(60) Provisional application No. 63/665,456, filed on Jun. 28, 2024.

(51) Int. Cl. B64G 1/22

(52) U.S. Cl. CPC B64G 1/2224

(57) ABSTRACT

Systems and methods for elastically foldable structures are described. The high-strain composite thin-shell structures offer high stiffness to mass ratio and increased packaging efficiency, with the additional advantage that their deployment is aided by releasing the strain energy stored in the elastic folds in a controlled quasistatic manner.

### CROSS-REFERENCE TO RELATED APPLICATIONS

The current application claims the benefit of and priority under 35 U.S.C. § 119 (e) to U.S. Provisional Patent Application No. 63/665,456 entitled “Structurally Connected Architecture Enabling Controlled Deployment of Elastically Foldable Flat Arrays” filed Jun. 28, 2024. The disclosure of U.S. Provisional Patent Application No. 63/665,456 is hereby incorporated by reference in its entirety for all purposes.

### FIELD OF THE INVENTION

The present invention generally relates to systems and methods for controlled deployment of elastically foldable arrays.

### BACKGROUND OF THE INVENTION

Origami and kirigami inspired techniques are being used to create efficient packing solutions for large deployable space structures, such as solar panels and antennas, by enabling compact stowage and deployment. Origami-inspired designs allow for these large, flexible structures to be folded into a smaller volume for launch and then deployed in space to achieve a larger surface area.

### BRIEF SUMMARY OF THE INVENTION

Many embodiments are directed to systems of controlled deployment of elastically foldable arrays. The elastically folded arrays in accordance with several embodiments have interconnected structures and can be deployed in a controlled manner. The controlled deployment process enables more robust unfolding sequences of the elastically foldable arrays. Various functional devices can be incorporated into the elastically folded arrays to be deployed in the desired environment.

Some embodiments include a deployable structure comprising: a platform with defining at least two lines dividing the platform into a plurality of portions; each portion comprises a plurality of elastically foldable strips with at least one connector connecting two adjacent strips in a portion; at least one strip of stretchable material positioned along and on top of each of the at least two lines; and a boom positioned along and under each of the at least two lines; wherein a first end of the at least one strip of stretchable material attaches to the boom and a second end attaches to a central mechanism positioned at a center of the platform; wherein each of the plurality of elastically foldable strips connects to the at least one strip of stretchable material; wherein the boom moves from a starting position near the central mechanism to an end position near a tip of each of the at least two lines and actuates a deployment of the plurality of elastically foldable strips such that the boom and the plurality of elastically foldable strips are deployed together and the structure is deployed in a quasistatic controlled manner; and wherein when the structure is deployed, the at least one strip of stretchable material is prestressed to provide structural stiffness to the structure.

In some embodiments, the at least one connector is an elastic hinge.

In some embodiments, two elastic hinges connect two adjacent elastically foldable strips.

In some embodiments, each of the plurality of elastically foldable strips folds in the middle.

In some embodiments, each of the at least one strip of stretchable material comprises a flexible region configured to be folded.

In some embodiments, the at least one strip of stretchable material comprises a carbon fiber tape and the flexible region comprises silicone.

In some embodiments, two parallel strips of stretchable material are positioned along and on top of each of the at least two lines.

In some embodiments, each of the plurality of elastically foldable strips has a trapezoidal shape, and each of the plurality of elastically foldable strips comprises two elastically deformable longerons and at least one elastically deformable batten; wherein a first elastically deformable longeron is shorter than a second elastically deformable longeron, and the at least one elastically deformable batten is transverse to the two elastically deformable longerons.

In some embodiments, each of the two elastically deformable longerons has a triangular rollable and collapsible cross section.

In some embodiments, the deployed structure is flat.

In some embodiments, each of the plurality of elastically foldable strips comprises a functional device selected from the group consisting of: a photovoltaic cell, a radio frequence radiator, an antenna, a microprocessor, a sensor, and an optical lens.

In some embodiments, the functional device is deposited on a flexible substrate.

In some embodiments, the structure is deployed in space under a zero-gravity force.

In some embodiments, the platform has a square shape; wherein the at least two lines are two diagonals dividing the platform into four quadrants.

Some embodiments include a method for deploying a structure, comprising: actuating at least two booms of a deployable structure; wherein the structure comprises a platform with defining at least two lines dividing the platform into a plurality of portions; wherein each portion comprises a plurality of elastically foldable strips with at least one connector connecting two adjacent strips in a portion; wherein at least one strip of stretchable material is positioned along and on top of each of the at least two lines, and each of the at least two booms is positioned along and under each of the at least two lines; wherein a first end of the at least one strip of stretchable material attaches to one of the at least two booms on a same line and a second end attaches to a central mechanism positioned at a center of the platform; wherein each of the plurality of elastically foldable strips connects to the at least one strip of stretchable material; unfolding the at least one strip of stretchable material and the plurality of elastically foldable strips such that the structure is deployed in a quasistatic controlled manner; and prestressing the at least one strip of stretchable material to provide structural stiffness to the structure.

In some embodiments, actuating the at least two booms with at least one motor.

In some embodiments, the at least one connector is an elastic hinge.

In some embodiments, two elastic hinges connect two adjacent elastically foldable strips.

In some embodiments, each of the plurality of elastically foldable strips unfolds in the middle.

In some embodiments, each of the at least one strip of stretchable material comprises a flexible region configured to be folded.

In some embodiments, the at least one strip of stretchable material comprises a composite material and the flexible region comprises silicone.

In some embodiments, the at least one strip of stretchable material is a tape and two parallel tapes are positioned along and on top of each of the at least two lines.

In some embodiments, each of the plurality of elastically foldable strips comprises two elastically deformable longeron and at least one elastically deformable batten; wherein each of the plurality of elastically foldable strips has a trapezoidal shape, a first elastically deformable longeron is shorter than a second elastically deformable longeron, and the at least one elastically deformable batten is transverse to the two elastically deformable longerons.

In some embodiments, each of the two elastically deformable longerons has a triangular rollable and collapsible cross section.

In some embodiments, the deployed structure is flat.

In some embodiments, each of the plurality of elastically foldable strips comprises a functional device selected from the group consisting of: a photovoltaic cell, a radio frequence radiator, an antenna, a microprocessor, a sensor, and an optical lens.

In some embodiments, the functional device is deposited on a flexible substrate.

In some embodiments, the structure is deployed in space under a zero-gravity force.

In some embodiments, the platform has a square shape; wherein the at least two lines are two diagonals dividing the platform into four quadrants.

Some embodiments include a deployable structure comprising: a platform with defining at least two lines dividing the platform into a plurality of portions; each portion comprises a plurality of elastically foldable strips with at least one connector connecting two adjacent strips in a portion; and at least one strip of stretchable material positioned along the at least two lines; wherein the at least one strip of stretchable material attaches to a central mechanism positioned at a center of the platform; wherein the at least one strip of stretchable material connects to each of the plurality of elastically foldable strips; wherein the at least one strip of stretchable material moves from a starting position near the central mechanism to an end position near a tip of each of the at least two lines and actuates a deployment of the plurality of elastically foldable strips such that the at least one strip of stretchable material and the plurality of elastically foldable strips are deployed together and the structure is deployed in a quasistatic controlled manner; and wherein when the structure is deployed, the at least one strip of stretchable material is prestressed to provide structural stiffness to the structure.

In some embodiments, the at least one connector is an elastic hinge.

In some embodiments, two elastic hinges connect two adjacent elastically foldable strips.

In some embodiments, each of the plurality of elastically foldable strips folds in the middle.

In some embodiments, each of the at least one strip of stretchable material comprises a flexible region configured to be folded.

In some embodiments, the at least one strip of stretchable material comprises a carbon fiber tape and the flexible region comprises silicone.

In some embodiments, two parallel strips of stretchable material are positioned along each of the at least two lines.

In some embodiments, each of the plurality of elastically foldable strips has a trapezoidal shape, and each of the plurality of elastically foldable strips comprises two elastically deformable longerons and at least one elastically deformable batten; wherein a first elastically deformable longeron is shorter than a second elastically deformable longeron, and the at least one elastically deformable batten is transverse to the two elastically deformable longerons.

In some embodiments, each of the two elastically deformable longerons has a triangular rollable and collapsible cross section.

In some embodiments, the deployed structure is flat.

In some embodiments, each of the plurality of elastically foldable strips comprises a functional device selected from the group consisting of: a photovoltaic cell, a radio frequence radiator, an antenna, a microprocessor, a sensor, and an optical lens.

In some embodiments, the functional device is deposited on a flexible substrate.

In some embodiments, the structure is deployed in space under a zero-gravity force.

In some embodiments, the platform has a square shape; wherein the at least two lines are two diagonals dividing the platform into four quadrants.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention.

FIG. 1 illustrates a schematic of a modular deployable structure in accordance with prior art.

FIG. 2 conceptually illustrates a deployment process of a modular structure in accordance with prior art.

FIG. 3 illustrates an interconnected modular structure in accordance with an embodiment.

FIG. 4 conceptually illustrates a quadrant of the interconnected structure with four strips in its deployed configuration in accordance with an embodiment.

FIG. 5A illustrates a quadrant of the interconnected structure in accordance with an embodiment.

FIG. 5B illustrates a quadrant of the interconnected structure in accordance with an embodiment.

FIG. 6 illustrates a process for manufacturing the dual matrix tapes in accordance with an embodiment.

FIGS. 7A and 7B illustrate quasistatic deployment with diagonal sliders for one quadrant of the 4-strip structure in folded and half deployed configurations respectively in accordance with an embodiment.

FIGS. 8A and 8B illustrate an experimental set-up of a simplified deployment mechanism and structure with pinched flanges in two configurations in accordance with an embodiment.

FIGS. 9A through 9C illustrate a quasistatic deployment of interconnected structure with two strips in three configurations in accordance with an embodiment.

FIGS. 10A through 10E illustrate folding simulation of one quadrant of interconnected structure with two strips in accordance with an embodiment.

FIGS. 11A and 11B illustrate a quadrant of a deployed interconnected structure and testing of the structure in accordance with an embodiment.

FIG. 12 illustrates the markers and offload point locations in accordance with an embodiment.

FIGS. 13A and 13B illustrate the gravity offload measurements setup in accordance with an embodiment.

FIGS. 14A and 14B illustrate measurement results in accordance with an embodiment.

FIG. 15 illustrates three different events during deployment in accordance with an embodiment.

FIG. 16 illustrates structural configuration with interconnection tapes and hinges in accordance with an embodiment.

### DETAILED DESCRIPTION OF THE INVENTION

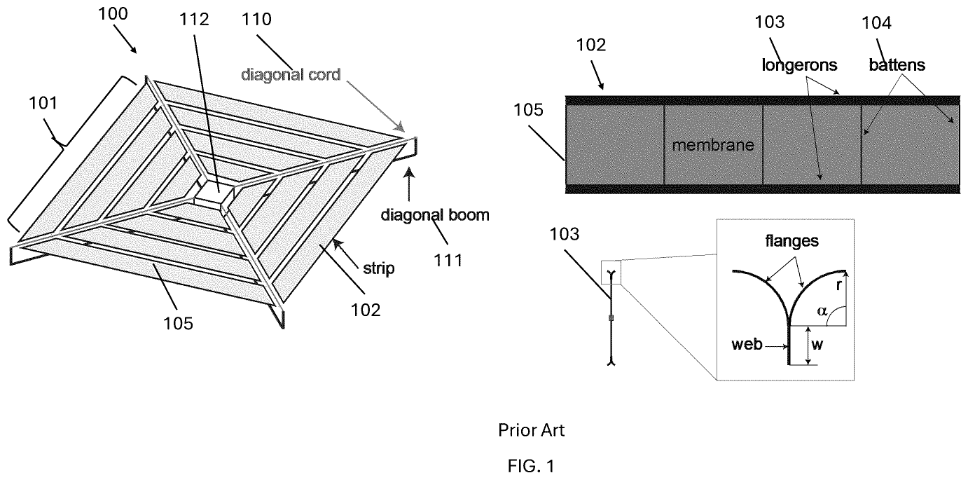

The increasing need for larger and lighter space structures has motivated advances in deployable thin shell structures, due to their packaging efficiency, high stiffness to mass ratio, and ability to self-deploy through the release of elastic stored strain energy when stowed. Modular deployable structures can act as a frame for multifunctional tiles, that collect sunlight through solar cells, convert it to electrical power using RF elements, and transmit it wirelessly to Earth. (See, e.g., U.S. Pat. No. 10,454,565B2 to S. Pellegrino, et al.; U.S. Pat. No. 10,992,253B2 to H. Atwater, et al.; U.S. Pat. No. 11,362,228B2 to H. Atwater, et al.; U.S. Pat. No. 11,063,356B2 to M. Arya, et al.; U.S. Pat. No. 10,696,428B2 to S. Pellegrino, et al.; the disclosures of which are incorporated by reference.) FIG. 1 illustrates a schematic of a modular deployable structure. The modular structure 100 has four quadrants 101, and each quadrant 101 has four strips 102. The bending-stiff trapezoidal strips 102 are arranged in four identical quadrants 101. The two edges of each strip are supported by composite longerons 103 and connected by transverse battens 104. The longerons 103 can have triangular rollable and collapsible (TRAC) cross-section. The battens 104 can be made of carbon fiber and each batten can have a rectangular cross section. The multifunctional tiles are mounted on a flexible substrate 105, attached to the battens 104 and longerons 103. The flexible substrate 105 can be a thin Kapton membrane. Neighboring strips 102 are joined through diagonal cords 110. The strips 102 are connected to the diagonal cords 110 by strip-cord connectors (not shown). The diagonal cords 110 can be prestressed by deployable diagonal booms 111 located below the cords 110. The diagonal cords 110 are suspended between a central deployment mechanism 112 and the tips of four diagonal booms 111. The deployment relies on tensioning or prestressing these cords 110 with constant-force retractors and releasing the central mechanism 112, while the internal strain energy stored within the packaged structure drives the dynamic deployment. (See, e.g., U.S. Pat. No. 11,772,826B2 to S. Pellegrino, et al.; U.S. Pat. No. 11,634,240B2 to S. Pellegrino, et al.; the disclosures of which are incorporated by reference.)

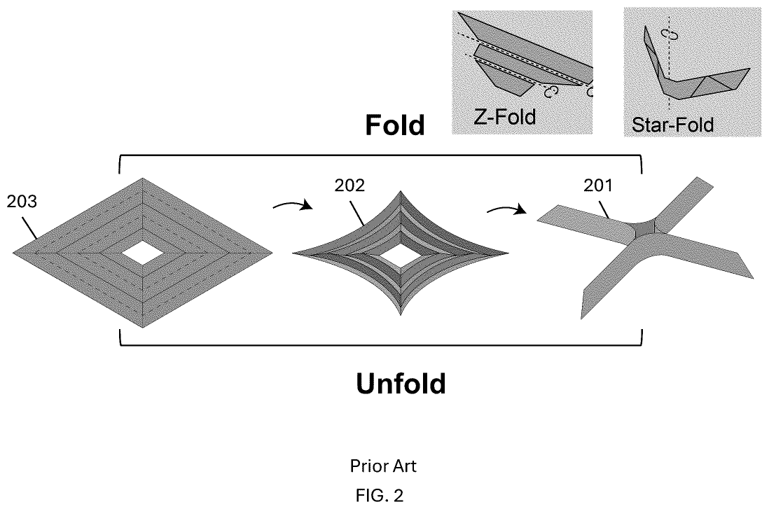

The modular structure can be deployed in a dynamic process from a folded structure to an unfolded structure. FIG. 2 conceptually illustrates a deployment process of a modular structure. Before deployment, the modular structure can be folded into a compact shape such as a cross shape 201. During deployment 202, the folded modular structure can be expanded by unfolding the elastically deformable longerons and battens. After deployment 203, the modular structure can be fully deployed showing four quadrants. The diagonal booms 111 are fully deployed. The ends of the diagonals cords 110 are pulled outwards by elastic springs. Central restraint is released.

However, many challenges come with these dynamically deployable structures. One challenge is the uncertainty of the dynamic deployment process. For example, a complex cord management system (using wires, pulleys, elastic springs, and storage boxes) is used for connecting between the central mechanism and the diagonal cords. One part of the complex connecting system failing to work may result in unsuccessful deployment. In addition, the dynamic deployment process is sensitive to initial conditions. The dynamic deployment relies on inertia effects for deployment and the initial conditions are not well defined. As factors of uncertainty increase, the behavior of the structure in space becomes ever more challenging to predict. Thus, enhancing the robustness of folding and deployment is important for reducing the probability of failure.

To overcome the challenges of the dynamic deployment systems, many embodiments implement a controlled deployment process. The controlled deployment process in accordance with several embodiments utilizes a more robust foldable structure. Several embodiments use elastic connector elements between adjacent strips in a quadrant of a modular structure. The elastic connector elements in accordance with several embodiments enable the formation of an interconnected modular structure. The interconnected structure has a controllable configuration compared to the structure connected by the diagonal cord. In some embodiments, diagonal tapes are implemented to connect the elastic strips. In other words, the strips terminate into diagonal tapes. Some embodiments eliminate the use of diagonal cords to connect the elastic strips. The tapes are attached to a tip of a boom on one end and the central mechanism on the other end. In certain embodiments, the tapes are attached only to the boom tips and the central mechanism. The tapes in accordance with several embodiments contain soft regions that allow localized folding. The interconnected configuration makes the modular structures more flexible such that it enables a controlled deployment process.

Many embodiments implement a quasistatic deployment process using deployment actuators. The deployment actuators substitute the force retractors in the dynamic deployment system. The quasistatic deployment process in accordance with several embodiments use the diagonal booms as actuators.

The structures and deployment processes in the following sections are described for one quadrant of a modular structure and each quadrant has four strips. To keep the structure as planar as possible during deployment, the inner and outer ends of the folded structure should be at the same height. Thus, the number of strips should be even. As can be readily appreciated, any of a variety of number of strips in a quadrant can be utilized as appropriate to the requirements of specific applications in accordance with various embodiments of the invention.

### Interconnected Structures

Many embodiments implement an interconnected structure for the controlled deployment of elastically foldable flat arrays. The interconnected structure is more controllable during deployment process. Such interconnected structure allows for controllable reconfiguration of three-dimensionally folded to flat deployed surfaces. In the interconnected structure, the adjacent strips are connected by elastic connector elements. In a modular structure, each of the strips can include a plurality of squares (also referred to as tiles) that can be elastically folded. Elastic connector elements such as (but not limited to) elastic hinges located between the strips can be used to form sub-folds.

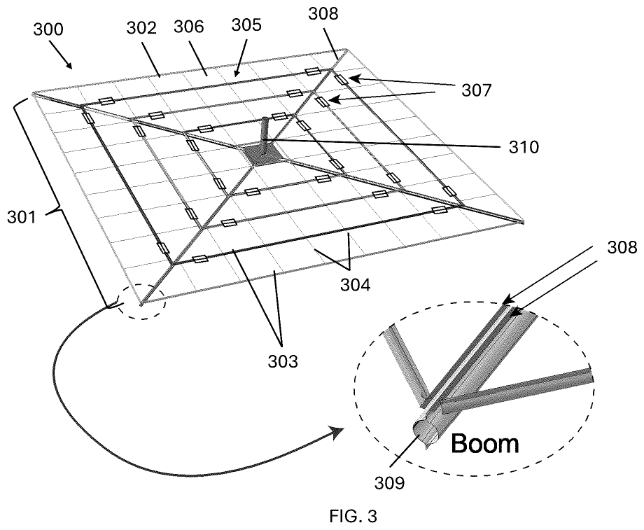

FIG. 3 illustrates an interconnected modular structure in accordance with an embodiment. The interconnected modular structure 300 has four identical quadrants 301, and each quadrant 301 has four strips 302. The dimensions of a quadrant can range from a few meters to tens of meters, or hundreds of meters. In some embodiments, the interconnected modular structure is referred to as a platform. As can be readily appreciated, the modular structure 300 can have a square shape or any other shape as appropriate to the requirements of specific applications in accordance with various embodiments of the invention. The modular structure 300 can be divided into four quadrants, or any number of quadrants as appropriate to the requirements of specific applications in accordance with various embodiments of the invention. Each of the strips 302 can have a trapezoidal shape. The two edges of each strip are supported by composite longerons 303 and connected by transverse battens 304. The longerons 303 can have TRAC cross-section. The battens 304 can be made of carbon fiber and each batten can have a rectangular cross section. Tiles of functional devices 306 can be mounted on a flexible substrate 305, attached to the battens 304 and longerons 303. The flexible substrate 305 can be, for example, a polymer, a composite, a film, or a membrane. In some embodiments, edges of the strips 302 are connected by elastic connector elements 307. Tapes 308 can be positioned along the diagonal lines of the square modular structure 300. In some embodiments, one strip of a stretchable material (such as a tape, or a carbon fiber tape) is positioned along a diagonal line (not shown). In some embodiments, two parallel strips of a stretchable material (such as tapes, or carbon fiber tapes) are positioned along a diagonal line as shown in FIG. 3. The strips 302 terminate into the diagonal strips of stretchable materials (such as tapes) 308. The deployable booms 309 are positioned underneath the diagonal lines. The strips of stretchable materials (such as tapes) 308 are attached to the tips of the diagonal booms 309 and the central mechanism 310. In certain embodiments, the tapes 308 attach only to the tips of the diagonal booms 309 and the central mechanism 310. The strips of stretchable materials (such as tapes) 308 can be made of composite materials. The strips of stretchable materials (such as tapes) 308 can contain soft regions that enable localized folding. Once deployed the diagonal composite tapes 308 are prestressed to provide the required structural stiffness. Packaging involves creating mountain and valley folds between the strips (Z-folding), collapsing the quadrants towards the center (star-folding) as shown in FIG. 2.

In some embodiments, the connector elements 307 can be flexible hinges. In several embodiments, the hinges can be elastic hinges. The hinges can deform during the deployment process. The hinges are positioned between adjacent strips and close to quadrant diagonals to control the structure's outer edges. The hinges can be made from flexible materials such as (but not limited to) polymers, composite materials, or thin plates. In certain embodiments, the hinges can be made of two leaves capable of rotating around a central axis. The hinges can be placed between adjacent strips.

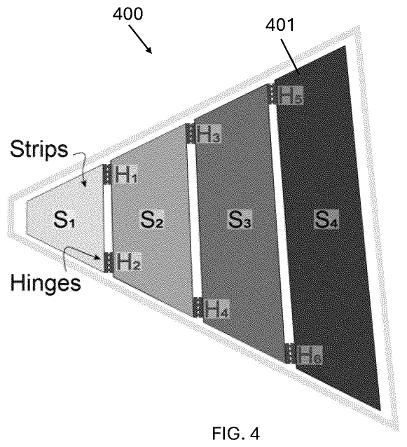

In several embodiments, the elastic connector elements 307 can be positioned close to the diagonal lines of the modular structure. FIG. 4 conceptually illustrates a quadrant of the interconnected structure with four strips in its deployed configuration in accordance with an embodiment. Sᵢ and Hᵢ denote the i^{th} strip and hinge respectively. The quadrant 400 has a shape of a trapezoid. The quadrant 400 can include four strips 401. Flexible hinges H1 and H2 connect the first strip S1 and the second strip S2. Flexible hinges H3 and H4 connect the second strip S2 and the third strip S3. Flexible hinges H5 and H6 connect the third strip S3 and the fourth strip S4. The hinges H1 through H6 are positioned close to the diagonals of the quadrant. As can be readily appreciated, any of a variety of strips in a quadrant, any number of hinges connecting different strips, and any position of the hinges can be utilized as appropriate to the requirements of specific applications in accordance with various embodiments of the invention.

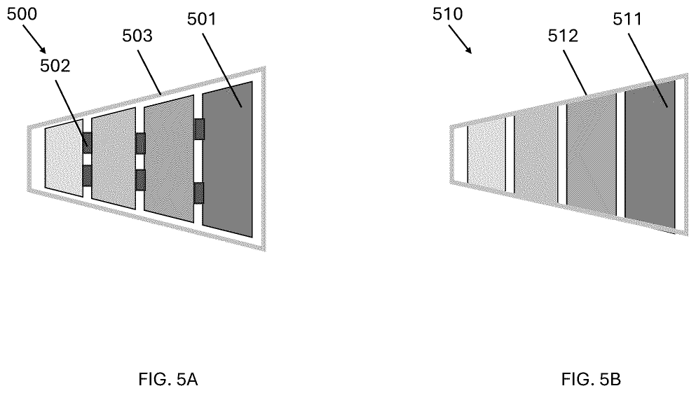

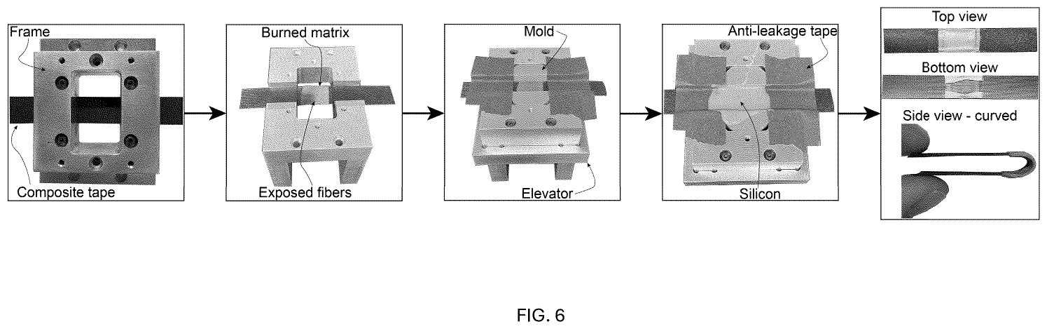

In some embodiments, the connector elements 307 can be positioned closer to the center of the modular structure. The positions of the elastic connector elements 307 and/or the number of elastic connector elements 307 for each strip can be optimized to achieve the desired folding performance of the modular structure. The positions and/or number of the elastic connector elements 307 can be different from the ones shown in FIG. 3 depending on the size of the modular structure and/or the number of strips in a quadrant. FIG. 5A illustrates a quadrant of the interconnected structure in accordance with an embodiment. The quadrant 500 has four strips 501. The hinges 502 connecting the strips 501 can be positioned further from the quadrant diagonals 503 and closer to the center of the strips 501. Tapes can be positioned on the quadrant diagonals 503. Folding of the tapes and the hinges enables the folding of the structure.

In some embodiments, the elastic connector elements 307 can be omitted and the strips terminate and connect with the diagonal tapes directly. Such embodiments reduce the overall part counts of the modular structure and enable a simplified and lighter structure. These structures can also simplify the manufacturing process. FIG. 5B illustrates a quadrant of the interconnected structure in accordance with an embodiment. The quadrant 510 has four strips 511. The strips 511 connect with the quadrant diagonals 512 directly. Tapes can be positioned on the quadrant diagonals 512. Folding of the tapes enables the folding of the structure.

In some embodiments, the tapes are attached to the foldable booms. When packaged, the tapes and the booms can be folded in a compact shape, such as the cross shape 201. The tapes can be made with light and sturdy materials such as (but not limited to) elastomers, composite, carbon fiber composite. Each of the tapes also includes a plurality of localized elastic folds that enable folding of the tape when packaged. The tapes are referred to as dual matrix tapes. In some embodiments, the localized elastic folds can enable bending of up to about 180°. In certain embodiments, the localized elastic folds can be made with pliable materials such as (but not limited to) soft polymers, epoxy, silicone.

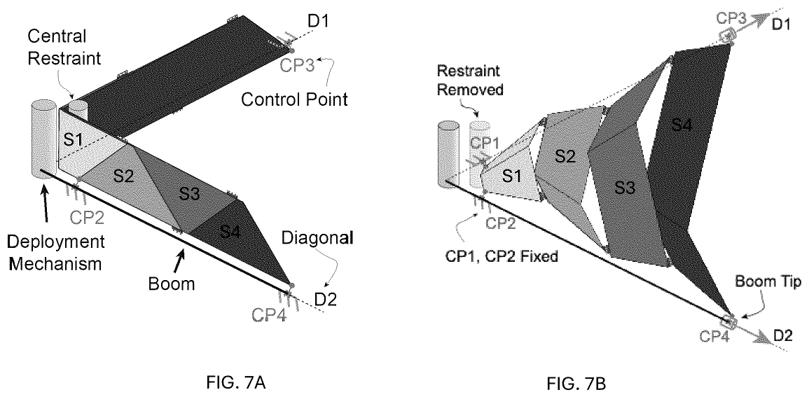

Some embodiments modify carbon fiber tapes to introduce localized fold regions. FIG. 6 illustrates a process for manufacturing the dual matrix tapes in accordance with an embodiment. Unidirectional carbon fiber tape (about 200 μm thick) can be processed to create flexible regions that allow tight folding, while also providing a stiff load path for prestressing. The carbon fiber tape can be secured in a frame during manufacturing. To enable high curvature in these regions, the original resin matrix is removed and replaced with a silicone matrix. The resin matrix is removed by carefully burning the matrix of the composite tape. Since this process makes the exposed fibers brittle and difficult to handle, a custom jig is developed to support the laminate throughout the burning and silicone application without moving the tape. The laminate is mounted on the frame, and the exposed area is burned. Exposed fibers can be seen under the burned resin matrix. Once the matrix is removed, a 3D-printed PLA mold is mounted on a block that aligns it with the tape. Degassed silicone is poured over the exposed fibers and gently scraped to ensure an even layer. The dual-matrix laminate is then left to cure for a period of time (from a few hours to a day depending on the silicone types). This method provides a simple way to manufacture dual-matrix composite materials. The resulting dual-matrix tape can be folded with high localized curvature. However, due to the relatively high viscosity of the silicone (about 30,000 cps), full impregnation of the fibers is not achieved, which may lead to local fiber damage and non-uniformities along the thickness. Some embodiments use silicone with lower viscosity of about 2,000 cps. The low viscosity silicone has a shorter cure time of about 4 hours. The processed tape contains a flexible region that allows folding. A side view of the processed tape shows folded and curved silicone region of the carbon tape.

The elastically foldable flat arrays with the modular structures in accordance with many embodiments can include various functional devices. The functional devices can be integrated into the tiles 306 of the modular structures. The functional devices can be placed on a flexible substrate 305 such as (but not limited to) a Kapton membrane. Examples of functional devices include (but are not limited to) photovoltaic cells, radio frequency radiators, antennas, microprocessors, sensors (such as, pressure sensors, acoustic sensors, temperature sensors), and/or optical lenses. The deployable flat arrays in accordance with many embodiments can be optimized to function in a desired environment such as (but not limited to) in space beyond Earth's atmosphere, on Earth, under water. As can be readily appreciated, any of a variety of functional device can be integrated into the foldable flat arrays as appropriate to the requirements of specific applications in accordance with various embodiments of the invention.

### Quasistatic Deployment Process

The dynamic deployment relies on inertia effects for deployment and the initial conditions are not well defined. Many embodiments implement a slowly moving boundary condition that can control a quasistatic deployment process. The quasistatic deployment process can have more precise controls during deployment. The structure is deployed by applying a gradual displacement to its outermost ends, while the innermost ends are held fixed. This can be achieved by connecting the innermost ends to the central deployment mechanism, and the outermost ends to the tips of deployable diagonal booms.

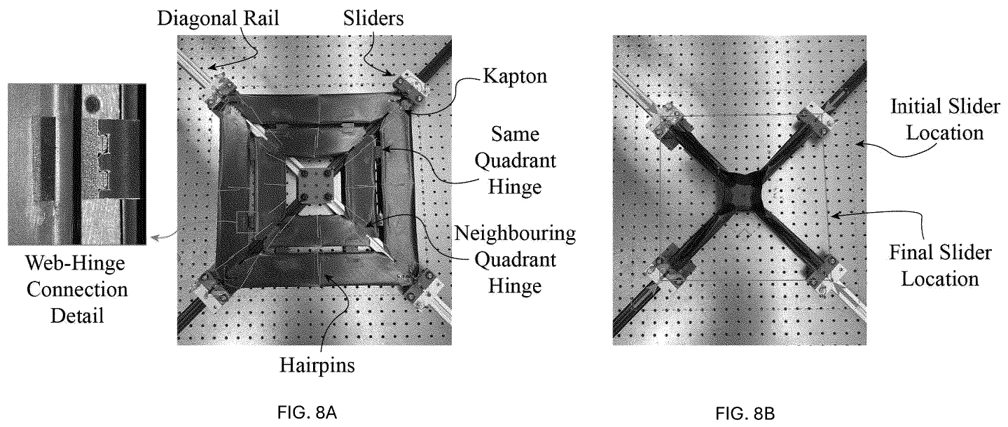

In some embodiments, the movable outermost points are modelled to as diagonal sliders that undergo controlled displacement. The center of the mechanism is modelled as a central shaft bounded by two plates, and a cylinder hinged to the bottom plate is used to hold the structure folded. FIGS. 7A and 7B illustrate quasistatic deployment with diagonal sliders for one quadrant of the 4-strip structure in folded and half deployed configurations respectively in accordance with an embodiment. FIG. 7A shows the folded structure with the deployment mechanism. The quadrant corners are referred to as control points (CP). CPᵢ indicates the i^{th} control point. The control points are attached to the deployable booms. CP1 and CP2 are fixed at the central mechanism. CP3 and CP4 follow the tips of the booms. The booms and the structure can be deployed together in accordance with some embodiments such that the unfolding process can be controlled. D1, D2 are the two diagonals of the quadrant. The folding process includes stacking the strips on top of each other (Z-folding), then creating a central 90° fold (star-folded configuration), and finally attaching the folded structure to the deployment mechanism through the sliders. In the folded configuration as shown in FIG. 7A, the deploying cylinder is rotated and locked in its vertical position to maintain the star-fold configuration, while the outermost sliders CP3, CP4 are held fixed. The deployment of the structure starts once the vertical cylinder is released and CP3, CP4 are moved along the quadrant diagonals to slowly bring the structure to its flat configuration. A partially deployed structure is shown in FIG. 7B.

Several embodiments provide a down-scaled structure and deployment mechanism for the interconnected structure. The lowest number of strips to demonstrate the controlled deployment process and interconnection structure is two. Composite hinges are used to connect adjacent strips of the same and neighboring quadrants. Instead of building complete strips, with longerons and battens, thin plates with TRAC-like edges can be manufactured. The hinges pass through a slit at the beginning of the top flange and are glued to the web of the strips. The simplified deployment mechanism includes a central cube and four diagonal rails, with sliding blocks used as sliders. The inner and outer corners of the first and last strip respectively, are suspended between the central cube and the brackets using Kapton membrane.

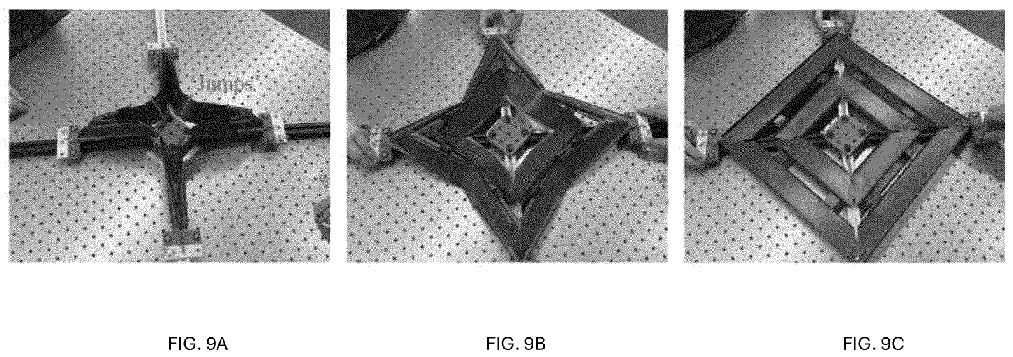

FIGS. 8A and 8B illustrate an experimental set-up of a simplified deployment mechanism and structure with pinched flanges in two configurations in accordance with an embodiment. The initially flat structure is folded by pinching the flanges using hairpins as shown in FIG. 8A. The structure is star-folded manually while the sliders are pushed towards the center of the mechanism as shown in FIG. 8B. Once the folded configuration has been reached, the location of the sliders is locked, and the hairpins are removed. The structure is then deployed by gradually displacing all the sliders simultaneously along the diagonals and away from the center of the mechanism.

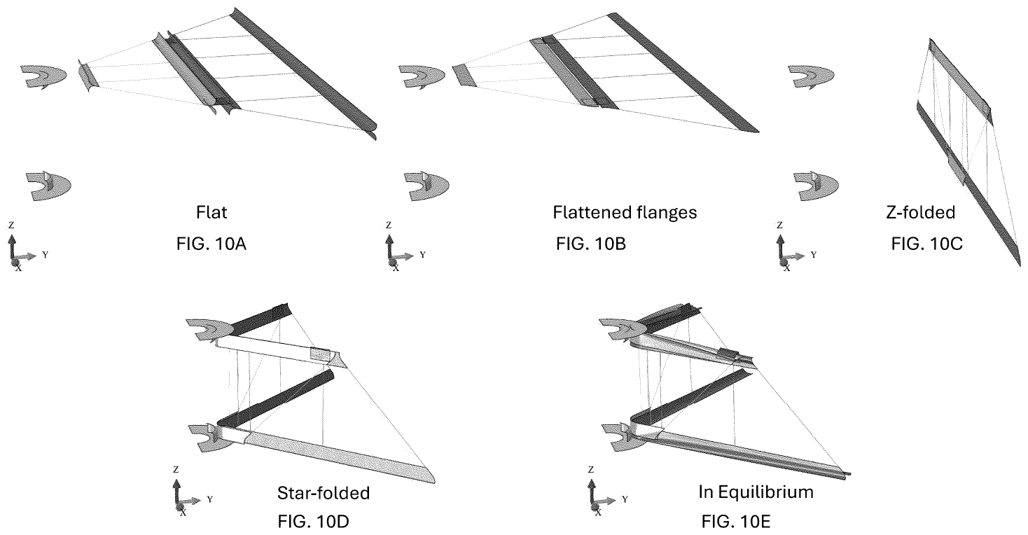

FIGS. 9A through 9C illustrate a quasistatic deployment of interconnected structure with two strips, in three configurations in accordance with an embodiment. After the hairpins are removed, the structure remains in the star-fold configuration when the sliders are held fixed, but the center of the structure jumps up as shown in FIG. 9A. As the sliders continue to move, the structure moves smoothly as shown in FIG. 9B and finally reaches its fully deployed configuration as shown in FIG. 9C. Thus, the interconnected structure and the quasistatic deployment allow for the intermediate configurations of the deployment to be carefully controlled.

The detailed folding and deployment behavior of this interconnected structure is rather complicated. A finite-element numerical model is used to gain a better understanding of these behaviors before manufacturing the actual structure. Due to the presence of elastic hinges, the folding configuration is not defined a priori, and the entire folding process has to be simulated.

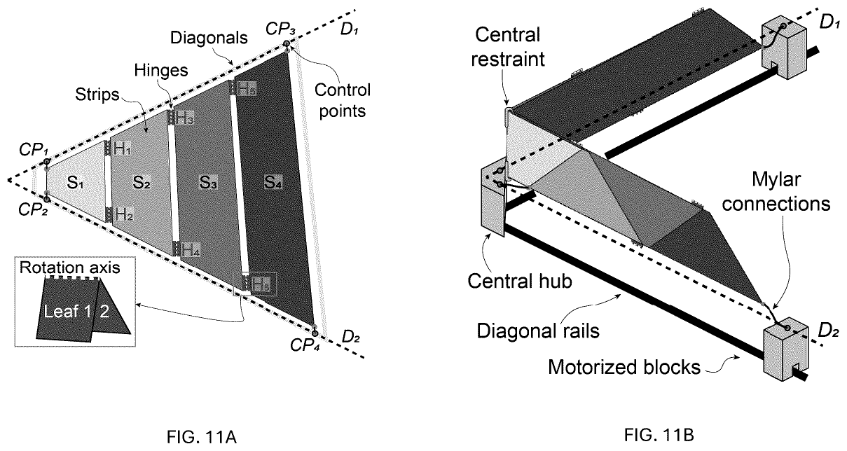

FIGS. 10A through 10E illustrate a folding simulation of one quadrant of interconnected structure with two strips in accordance with an embodiment. An interconnected structure of one quadrant with two strips is considered as shown in FIG. 10A. The distance between two longerons of one strip is about 200 mm. The flanges have a radius of about 13.6 mm, a subtended angle of 105° and a layup of ±45_{GFPW}/0_{CF}/±45_{GFPW}. The web has a layup of ±45_{GFPW}/0_{CF}/±45_{3,GFPW}/0_{CF}/±45_{GFPW}. The hinges are about 50 mm long and about 55 mm wide rectangular thin shells, with the same material properties as the flanges. The maximum quadrant length is about 1.21 m, while the horizontal distance between the quadrant diagonals and the diagonal batten of the last strip is about 15.5 mm. The innermost and outermost strip ends are connected to reference points representing the diagonal sliders using MPC beam connectors.

The folding of this elastic structure is achieved by imposing the rotation of certain node sets as described below. To simulate the Z-folding of the structure, the flanges are initially flattened by applying a pressure of about 0.001 MPa on their entire surface shown in FIG. 10B. Then, the nodes corresponding to the webs, battens and hinges of strips of odd and even number are rotated 0.99×π/2 clockwise and counterclockwise around the x-axis respectively shown in FIG. 10C. For the star-folding, the nodes of the above node set, except for the ones corresponding to a central region of about 50 mm length, are rotated π/4 clockwise or counterclockwise around the z-axis, if they have positive or negative x-coordinate respectively. Simultaneously, the central mechanism is brought closer to the structure, while a restraining pressure of 0.01 MPa is applied to represent effect of a locking cylinder.

Once the star-fold shape is achieved (FIG. 10D), the sliders are constrained to remain along the diagonals, while the outermost ones are temporarily held fixed against translations. Then, the structure is allowed to self-equilibrate, by smoothly decreasing the flattening pressure and increasing the gravity load to 9.806 m/s² and stagnation pressure load to 1.4×10⁻⁶ Pa, while the rotational boundary conditions are removed. For the deployment, the restraining pressure is slowly released, representing the release of the locking cylinder, while the outermost sliders remain fixed (FIG. 10E). Afterwards, the outermost sliders are slowly moved along the diagonals until the structure is fully deployed.

To dampen high frequency oscillations, a viscous pressure of 3×10⁻² Pa is applied to all surfaces after the flattening of the flanges, and for the rest of the simulation. Bulk viscosity is considered, but found to be inadequate, since the oscillations in this simulation are not created by stress waves. For the contact formulation, general contact is prescribed between the specific surface pairs needed at each step, to reduce the simulation time.

FIG. 10E presents a snapshot of the folded structure in equilibrium, prior to the start of the deployment. In agreement with the experimental observations (FIG. 9A), the simulated structure maintains its star-folded shape once the restraining pressure is removed. This equilibrium reached by the structure in both simulation and experiment provides a strong indication that the quasistatic behavior of the deployment can be simulated successfully.

Some embodiments utilize discrete hinge pairs between adjacent strips. For each strip, two hinge pairs are placed near the quadrant diagonals to imitate the effect of the tape connections. The goal of this simplified architecture is to examine the coupling in the strip kinematics resulting from connections near the diagonals. Since the primary function of these hinges is to control the deployment kinematics rather than transmitting structural loads (i.e. prestress), they are designed as mechanical pivots. Therefore, the hinge includes two separate composite leaves with an epoxy matrix, rotating around a central axis.

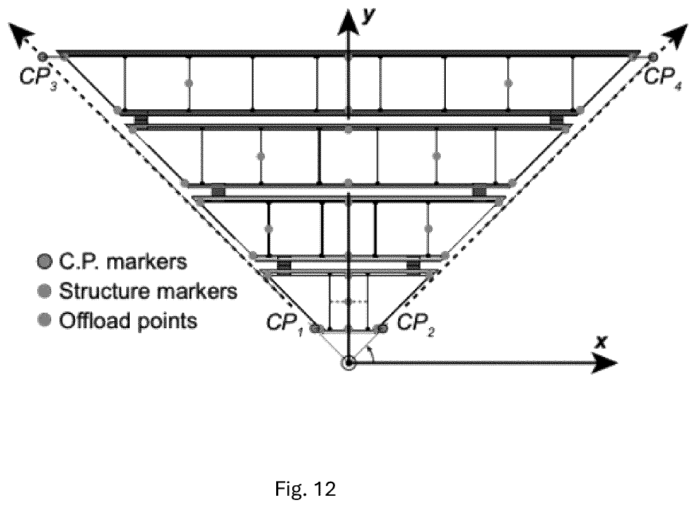

FIGS. 11A and 11B illustrate a quadrant of a deployed interconnected structure and testing of the structure in accordance with an embodiment. Adjacent strips (Si, i=1, . . . , 4) are connected by hinges (Hn, n=1, . . . , 6). Each hinge includes two elastic composite leaves that are able to rotate around a central axis as shown in FIG. 11A. The deployment is guided by moving the quadrant corners, i.e. control points (CPj). The innermost control points (j=1, 2) are fixed, while the outermost ones (j=3, 4) are slowly moved along the diagonals (Dk, k=1, 2), to achieve a quasistatic deployment of the structure. The deployment of the structure can be tested experimentally by mounting the inner control points (j=1, 2) to a central hub, while the outermost ones (j=3, 4) are attached to motorized blocks sliding along diagonal rails as shown in FIG. 11B. The structure is connected to the control points via Mylar film strips. The folded configuration is maintained using restraints (hairpins) placed at the centers of the strips. Deployment begins once these restraints are removed and proceeds as the motorized blocks are moved outward.

The hinge has a layup of ±45_{GFPW}/0_{CF}/±45_{3,GFPW}/0_{CF}/±45_{GFPW}, similar to that of the web, and is manufactured using a single-cure process. Two prepregs, with dimensions Wₕ×Lₕ, are stacked, and a thin steel wire, with about 0.32 mm diameter, embedded in a polyamide tube, with about 0.47 mm diameter, is placed between them at the rotation axis location (i.e., at their half-length). The polyamide tube prevents the steel wire from bonding to the prepregs. After curing, a pattern is cut around the rotation axis to form the hinge leaves and knuckles. With the same pattern, the tubing is cut, leaving the wire free to act as the rotation axis. To attach them to the rest of the structure, the hinges pass through a slit at the beginning of the top flange and are glued to the web of the longerons.

Several embodiments provide gravity offload experiments with the interconnected structures. In gravity-assisted deployments, the structure becomes partially deployed immediately upon release of the central restraint, complicating the controllability of kinematics. In horizontal deployments, where the deployment direction is normal to the gravity direction, increased friction between the structure and the mounting table is observed, leading to interference with the natural deployment behavior.

For more accurate ground-testing deployment experiments, gravity effects can be minimized with gravity offload systems, that apply a force opposite and equal to the gravitational load. Selecting an appropriate offload system is important, as inadequate compensation can affect the deployment behavior. Active offloading systems use real-time feedback and actuation to provide precise and continuous gravity compensation throughout the entire deployment. Because of the complexity and cost of such systems, a passive offloading system using helium balloons is adopted. This approach is particularly attractive due to the quasistatic nature of the deployment and the low structural weight of about 118 grams. A total of nine helium balloons can be sufficient to successfully compensate for gravitational effects. To minimize helium leakage over time, 22-inch Mylar balloons are selected due to the low permeability of Mylar film.

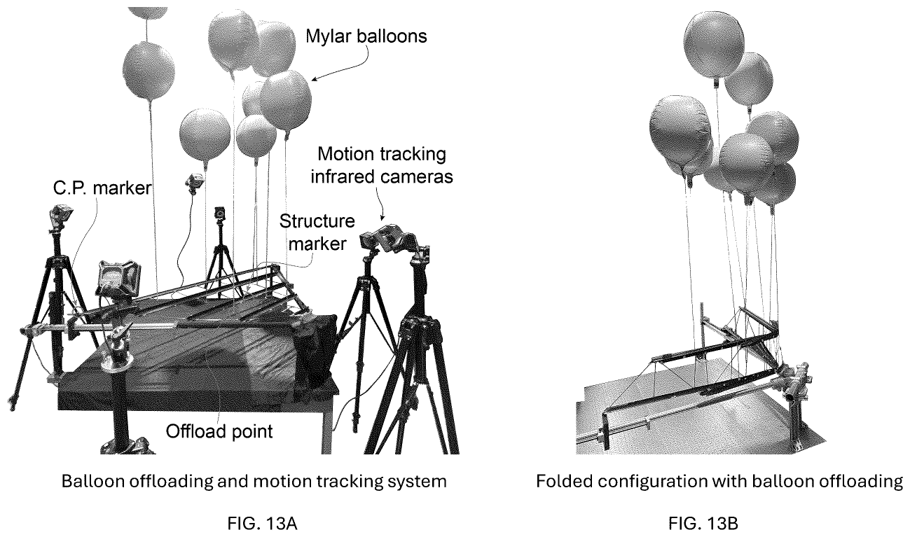

Gravity compensation forces should be applied at the structure's center of mass. However, the center of mass of the entire structure varies during deployment. To address this, the structure is divided into sub-components: since each strip folds in the middle, the center of mass of each half-strip is not expected to vary significantly throughout the deployment. This localized approach enables effective gravity offloading. Since no structural element lies exactly at the center of mass of each half-strip, the center of the nearest batten—being a relatively stiff component—is selected as the gravity compensation point. The exception to this rule is the first strip. Due to its short length, the center of the full strip is used instead. FIG. 12 illustrates the markers and offload point locations in accordance with an embodiment. At each of these points (green dots in FIG. 12), balloons are filled with enough helium to balance lead spheres whose weight match the mass of the corresponding half-strip.

Based on this assumption, an approximate linear mass density γ̅ and the i^{th} strip's weight mᵢ is calculated as:

$$\overline{γ} = \frac{{m}_{tot}}{{\sum }_{i = 1}^{k} ( {L}_{s , i} + {L}_{l , i} )} , {m}_{i} = \overline{γ} \cdot ( {L}_{s , i} + {L}_{l , i} ) , i = 1 , … , k$$

where mₜₒₜ=118 grams is the total weight of the structure, k=4 is the total number of strips, and L_{s,i} and L_{l,i} are the lengths of the strip's shortest and longest longeron respectively. This approximation for the mass of strips is considered sufficient. Table 1 lists mass of the strips based on longeron's lengths.

TABLE 1
Mass of strips based on longeron's lengths

| Strip | Longeron | Length (mm) | Mass mᵢ (g) |
|---|---|---|---|
| 1 | Short | 217.7 | 10.5 |
| | Long | 617.7 | |
| 2 | Short | 723.8 | 23.2 |
| | Long | 1123.8 | |
| 3 | Short | 1229.9 | 35.9 |
| | Long | 1629.9 | |
| 4 | Short | 1736.1 | 48.6 |
| | Long | 2136.1 | |

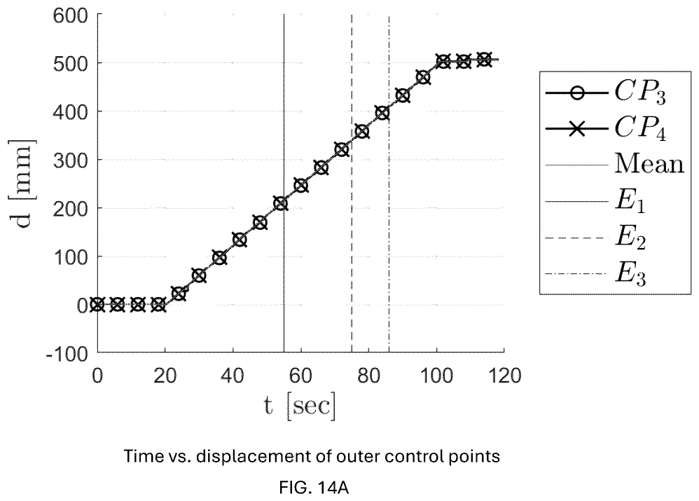

FIGS. 13A and 13B illustrate the gravity offload measurements setup in accordance with an embodiment. One fully inflated balloon is attached to the first strip; two partially inflated balloons are used for the two compensation points of the second strip; two fully inflated balloons are used for the third strip; and four fully inflated balloons, two attached to each compensation point, are used for the fourth strip, as shown in FIG. 13A. By using cords of different lengths to attach the balloons to the structure, interference between the balloons can be avoided in all configurations of the structure, including the initial folded state as shown in FIG. 13B.

The trajectories of selected points are recorded throughout the deployment using a motion tracking system. Reflective markers are attached to these points, and infrared cameras capture their three-dimensional coordinates in real time. Each marker point on the structure includes two hemispheres mounted symmetrically with respect to the mid-plane of the structure, forming a complete sphere and ensuring visibility from multiple cameras throughout the deployment. To minimize interference with the rest of the structure and limit additional mass, hemispherical markers of 3 mm diameter are used. Since each strip behaves as an elastic hinge with a central fold, that does not move along its length, six markers are placed on strip i, labeled as sᵢⱼ and lᵢⱼ, corresponding to the shortest and longest longeron, respectively, where j=0, 1, 2 indicates the center, the left diagonal, and the right diagonal as shown in FIG. 13B. Larger markers, with a 9.5 mm diameter, are placed at the four control points (CPs), as they are rigidly mounted on the mechanism and the motorized sliders, where mass and interference are not a concern.

The recorded coordinates (x₀, y₀, z₀) are transformed into two Cartesian coordinate systems. In the first coordinate frame [symbol] , the x-axis is defined as the vector starting from the midpoint C̅P̅₁₂ of the inner control points (CP₁ and CP₂) and ending at CP₂. To ensure orthogonality of the coordinate frame, the z-axis is defined as the cross product of the x-axis and the vector starting from the origin and ending at the midpoint C̅P̅₃₄ of the outer control points (CP₃ and CP₄). The y-axis is then computed as the cross product of the z-axis and the x-axis. To align the origin to the center of the quadrant, it is translated from C̅P̅₁₂ along the y-axis by a distance equal to half the distance between the inner control points, since they lie along the ±45° directions. A rotation matrix is then constructed, with its rows corresponding to the orthonormal unit vectors \hat{x}, ŷ, \hat{z} defining the local coordinate frame. Subsequently, a second transformation is applied by rotating by 45° the coordinate system around the z-axis, resulting in a rotated frame [symbol] where the x′- and y′-axes align with the quadrants' right and left diagonals, respectively. The transformations are as follows:

$$x = \vec{{CP}_{2}} - \vec{{\overline{CP}}_{12}} , \hat{x} = \frac{x}{‖ x ‖} ,$$

$$y = z \times x , \hat{y} , = \frac{y}{‖ y ‖} ,$$

$$z = - x \times ( - \frac{\vec{{\overline{CP}}_{34}}}{‖ \vec{{\overline{CP}}_{34}} ‖} ) , \hat{z} = \frac{z}{‖ z ‖}$$

$$\vec{O} = \vec{{\overline{CP}}_{12}} - \hat{y} \cdot \frac{\vert \vec{{CP}_{2}} - \vec{{CP}_{1}} \vert}{2} ,$$

$${R}_{F} = [ \begin{matrix}\hat{{x}^{T}} \\ \hat{{y}^{T}} \\ \hat{{z}^{T}}\end{matrix} ]$$

$${R}_{{F}^{′}} = [ \begin{matrix}cos \frac{π}{4} & sin \frac{π}{4} & 0 \\ - sin \frac{π}{4} & cos \frac{π}{4} & 0 \\ 0 & 0 & 1\end{matrix} ]$$

$$[ \begin{matrix}x \\ y \\ z\end{matrix} ] = {R}_{F} \cdot ( [ \begin{matrix}{x}_{0} \\ {y}_{0} \\ {z}_{0}\end{matrix} ] - \vec{O} )$$

$$[ \begin{matrix}{x}^{′} \\ {y}^{′} \\ {z}^{′}\end{matrix} ] = {R}_{{F}^{′}} \cdot [ \begin{matrix}x \\ y \\ z\end{matrix} ]$$

The two coordinate frames are schematically shown in FIG. 12. For the control points, the displacement along the diagonals is denoted by d, while the displacement in the normal direction is denoted by n. Specifically, for CP₁, CP₃ this corresponds to d=y′ and n=x′, whereas for CP₂, CP₄ to d=x′ and n=y′. The outer control points are connected to motorized blocks that slide along diagonal rails, guiding the deployment.

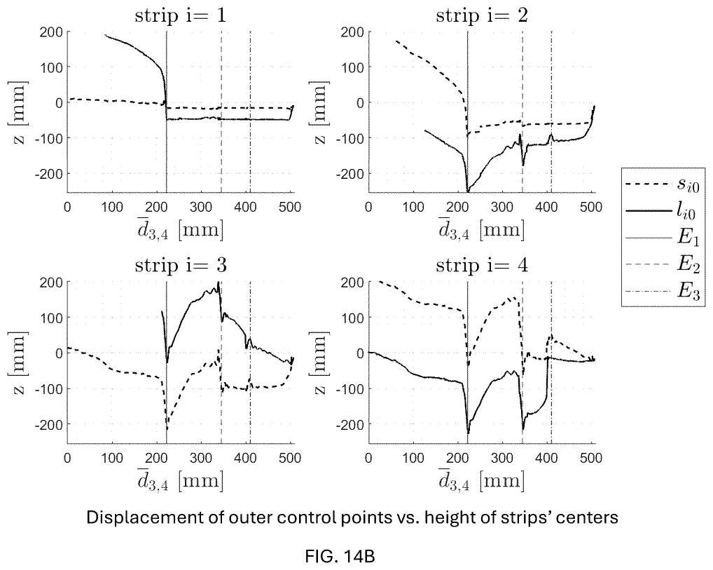

FIGS. 14A and 14B illustrate measurement results in accordance with an embodiment. As illustrated in FIG. 14A, the diagonal displacement over time shows that the full deployment takes 80 seconds, during which the sliders move a total distance of about 500 mm. The actuators are observed to maintain a constant velocity of the sliders throughout the deployment, with zero velocity at both the start and the end.

An important measurement during deployment is the height of the center points of all strips as shown in FIG. 14B. These heights define the sequence in which the strips deploy, providing valuable insight into the structure's kinematics. They can also help identify potential interference between the strips themselves, as well as with other parts of the deployment mechanism.

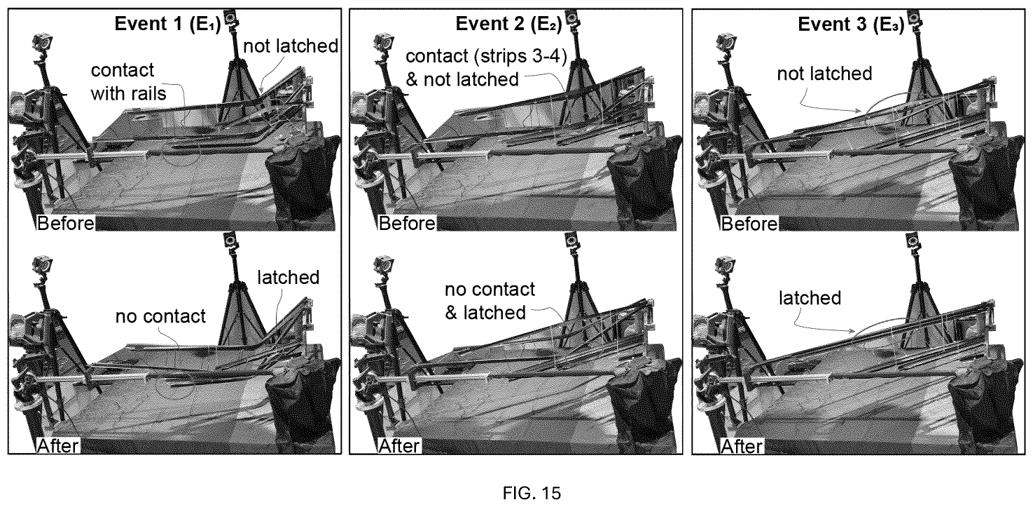

FIG. 15 illustrates three different events throughout deployment in accordance with an embodiment. The first one, E₁, occurs at t_{E}_{₁}=55 sec and d̅_{3,4}=222 mm. It corresponds to the structure losing contact with the diagonal rails and the latching of the long longeron of the first strip (l₁) and the short longeron of the second strip (s₂). The second event, E₂, occurs at t_{E}_{₂}=75 sec and d̅_{3,4}=345 mm, indicating the separation of the previously nested third and fourth strips, and the latching of the long longeron of the second strip (l₂) and the short longeron of the third strip (s₃). The third event, E₃, occurs at t_{E}_{₃}=86 sec and d̅_{3,4}=410 mm, corresponding to the latching of the long longeron of the third strip l₃ and both the short and long longerons of the fourth strip s₄, l₄. After the final event, all strips are fully deployed. Further displacement of the sliders applies tension to the structure, eventually bringing all center markers to the same final height.

The longerons latch in a sequential manner starting from the shortest one. Drops in the height of the strip centers are associated with changes in contact conditions, either due to interference with the deployment mechanism (as in E₁) or between different strips (as in E₂). These contact changes appear to be the main driver for oscillations around the horizontal plane defined by the control points during deployment, preventing the centers from following a smooth, continuous descent toward that plane.

Some embodiments perform the measurements replacing the diagonal battens with continuous composite tapes that run across all strips, which can prestress the entire structure. The Z-folding required for compact packaging calls for tapes capable of surviving high fold curvatures between adjacent strips. The hinge design with rotating leaves is not applicable in this case, as tapes with continuous fiber reinforcement are required to effectively transfer prestress throughout the entire structure. To achieve the necessary compliance in these fold regions, dual-matrix composite tapes are used. Dual-matrix composites feature continuous fiber reinforcement embedded in two distinct matrix materials: a flexible elastomer in the localized fold regions and a stiff epoxy in the surrounding tape. These continuous interconnection composite tapes with localized folds can be integrated with the interconnection composite hinges, broadening the range of possible interconnected architectures.

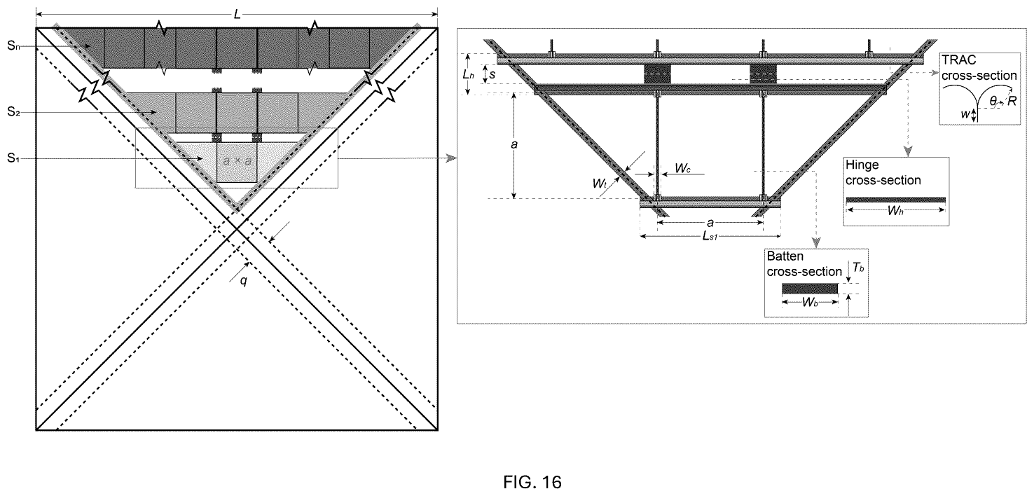

FIG. 16 illustrates structural configuration with interconnection tapes and hinges in accordance with an embodiment. The structure includes four identical quadrants that form a square with edge length L. Each quadrant is formed by n trapezoidal strips. Each strip includes two TRAC longerons connected by rectangular battens. The strips are constructed from repeating unit cells of size a×a, formed by the midlines of the adjacent battens and the webs (flat region) of the longerons. The strips within each quadrant are connected by two continuous diagonal tapes.

The main geometrical parameters are the unit cell size a, the normal distance between the center lines of adjacent diagonal tapes q, the distance between the outermost points of the flanges (arched regions) of adjacent longerons s, and the total number of strips n. The lengths of all longerons are determined from the length of the shortest longeron of the first strip S₁. This length (Lₛ₁) is calculated as:

$${L}_{s 1} = a + {W}_{c} + 2 \cdot ( {W}_{t \sqrt{2}} + w )$$

so that it fits exactly one square unit cell, the longeron-batten connectors of width W_{c}, and both tapes with width Wₜ. Here w is the web length.

The length of the next longeron, which is the longest longeron of the first strip (l₁), is selected to ensure that the tape is fully integrated within the web. The lengths of the longerons for the remaining strips are then determined based on the spacing s, while maintaining the same constraints on the tape's position within the web.

If the continuous tapes are combined with interconnection hinges of length Lₕ, spanning the distance between the webs, then the strip gap s can be expressed by:

$$s = g + 2 \cdot ( w + R \cdot θ ) - 2 \cdot ( w + R )$$

Here g is the gap between adjacent longerons once they are flattened, and R the flange radius and θ the flange angle. This ensures that the chosen hinge length can accommodate fully flattened flanges, which is required for Z-Folding. The placement and number of hinges are non-trivial design choices, with the only reasonable constraint being that the hinges should align with the battens due to their higher stiffness. Table 2 lists the values of the parameters for the structure with composite tapes.

TABLE 2
Geometric parameters of interconnected structures

| Driving parameters | Value | | Driven parameters | Value | |
|---|---|---|---|---|---|
| a | 200 | mm | Lₛ₁ | 266 | mm |
| g | 7 | mm | Lₕ | 78 | mm |
| q | 20 | mm | s | 37 | mm |
| n | 4 | | L | 2.3 | m |
| TRAC and | | | Other cross | | |
| hinge parameters | Value | | sectional parameters | Value | |
| w | 8 | mm | W_{b} | 4 | mm |
| R | 13 | mm | T_{b} | 1.1 | mm |
| θ | 120° | | W_{c} | 14 | mm |
| Wₕ | 50 | mm | Wₜ | 12.7 | m |

### EXEMPLARY EMBODIMENTS

Although specific embodiments of systems and apparatuses are discussed in the following sections, it will be understood that these embodiments are provided as exemplary and are not intended to be limiting.

### Example 1: Longeron Manufacturing Process

Some embodiments use a single-cure process to manufacture the longerons to reduce the twist of post-cure shapes produced by the double-cure process. The twist may be caused by slight asymmetries in the cross-sections. The manufacturing process begins with two pre-preg laminates, each with a layup of ±45_{GFPW}/0_{CF}/±45_{GFPW} and a thickness of 0.08 mm. Here, CF denotes a 30 gsm thin ply with unidirectional carbon fibers, and GFPW denotes a 25 gsm plain weave glass scrim impregnated with resin. Each laminate is placed onto a U-shaped aluminum mold, and an additional ±45_{GFPW} layer is added in the web region. This layer can be used to bond the two laminates when the longerons are built with the double-cure process. Although bonding is no longer required in the single-cure method, this layer is retained due to prior material characterization and its negligible effect on the final laminate properties. A thin Teflon film is used to cover all exposed laminate surfaces to constrain resin flow. The molds are then aligned, bonded, and the entire assembly is cured in an autoclave under vacuum.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

As used herein, the singular terms “a”, “an”, and “the” may include plural referents unless the context clearly dictates otherwise. Reference to an object in the singular is not intended to mean “one and only one” unless explicitly so stated, but rather “one or more”.

As used herein, the terms “approximately”, and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

1. A deployable structure comprising:
a platform with defining at least two lines dividing the platform into a plurality of portions;
each portion comprises a plurality of elastically foldable strips with at least one connector connecting two adjacent strips in a portion;
at least one strip of material positioned along and on top of each of the at least two lines; and
a boom positioned along and under each of the at least two lines;
wherein a first end of the at least one strip of material attaches to the boom and a second end attaches to a central mechanism positioned at a center of the platform;
wherein each of the plurality of elastically foldable strips connects to the at least one strip of material;
wherein the boom moves from a starting position near the central mechanism to an end position near a tip of each of the at least two lines and actuates a deployment of the plurality of elastically foldable strips such that the boom and the plurality of elastically foldable strips are deployed together and the structure is deployed in a quasistatic controlled manner; and
wherein when the structure is deployed, the at least one strip of material is prestressed to provide structural stiffness to the structure.

2. The structure of claim 1, wherein the at least one connector is an elastic hinge.

3. The structure of claim 2, wherein two elastic hinges connect two adjacent elastically foldable strips.

4. The structure of claim 1, wherein each of the plurality of elastically foldable strips folds in the middle.

5. The structure of claim 1, wherein each of the at least one strip of material comprises a flexible region configured to be folded.

6. The structure of claim 5, wherein the at least one strip of material comprises a carbon fiber tape and the flexible region comprises silicone.

7. The structure of claim 1, wherein two parallel strips of material are positioned along and on top of each of the at least two lines.

8. The structure of claim 1, wherein each of the plurality of elastically foldable strips has a trapezoidal shape, and each of the plurality of elastically foldable strips comprises two elastically deformable longerons and at least one elastically deformable batten; wherein a first elastically deformable longeron is shorter than a second elastically deformable longeron, and the at least one elastically deformable batten is transverse to the two elastically deformable longerons.

9. The structure of claim 8, wherein each of the two elastically deformable longerons has a triangular rollable and collapsible cross section.

10. The structure of claim 1, wherein the deployed structure is flat.

11. The structure of claim 1, wherein each of the plurality of elastically foldable strips comprises a functional device selected from the group consisting of: a photovoltaic cell, a radio frequence radiator, an antenna, a microprocessor, a sensor, and an optical lens.

12. The structure of claim 11, wherein the functional device is deposited on a flexible substrate.

13. The structure of claim 1, wherein the structure is deployed in space under a zero-gravity force.

14. The structure of claim 1, wherein the platform has a square shape; wherein the at least two lines are two diagonals dividing the platform into four quadrants.

15. A method for deploying a structure, comprising:
actuating at least two booms of a deployable structure;
wherein the structure comprises a platform with defining at least two lines dividing the platform into a plurality of portions;
wherein each portion comprises a plurality of elastically foldable strips with at least one connector connecting two adjacent strips in a portion;
wherein at least one strip of material is positioned along and on top of each of the at least two lines, and each of the at least two booms is positioned along and under each of the at least two lines;
wherein a first end of the at least one strip of material attaches to one of the at least two booms on a same line and a second end attaches to a central mechanism positioned at a center of the platform;
wherein each of the plurality of elastically foldable strips connects to the at least one strip of material;
unfolding the at least one strip of material and the plurality of elastically foldable strips such that the structure is deployed in a quasistatic controlled manner; and
prestressing the at least one strip of material to provide structural stiffness to the structure.

16. The method of claim 15, wherein actuating the at least two booms with at least one motor.

17. The method of claim 15, wherein the at least one connector is an elastic hinge.

18. The method of claim 16, wherein two elastic hinges connect two adjacent elastically foldable strips.

19. The method of claim 15, wherein each of the plurality of elastically foldable strips unfolds in the middle.

20. The method of claim 15, wherein each of the at least one strip of material comprises a flexible region configured to be folded.

21. The method of claim 20, wherein the at least one strip of material comprises a composite material and the flexible region comprises silicone.

22. The method of claim 15, wherein the at least one strip of material is a tape and two parallel tapes are positioned along and on top of each of the at least two lines.

23. The method of claim 15, wherein each of the plurality of elastically foldable strips comprises two elastically deformable longeron and at least one elastically deformable batten; wherein each of the plurality of elastically foldable strips has a trapezoidal shape, a first elastically deformable longeron is shorter than a second elastically deformable longeron, and the at least one elastically deformable batten is transverse to the two elastically deformable longerons.

24. The method of claim 23, wherein each of the two elastically deformable longerons has a triangular rollable and collapsible cross section.

25. The method of claim 15, wherein the deployed structure is flat.

26. The method of claim 15, wherein each of the plurality of elastically foldable strips comprises a functional device selected from the group consisting of: a photovoltaic cell, a radio frequence radiator, an antenna, a microprocessor, a sensor, and an optical lens.

27. The method of claim 26, wherein the functional device is deposited on a flexible substrate.

28. The method of claim 15, wherein the structure is deployed in space under a zero-gravity force.

29. The method of claim 15, wherein the platform has a square shape; wherein the at least two lines are two diagonals dividing the platform into four quadrants.
